(19) United States
(12) Patent Application Publication
(10) Pub. No.: US 2006/0156257 A1
(43) Pub. Date: Jul. 13, 2006

(54) Method and system for rapid memorization and learning

(76) Inventors: Yen-Fu Chen, Austin, TX (US); John Hans Handy-Bosma, Cedar Park, TX (US); Keith Raymond Walker, Austin, TX (US)

Correspondence Address: IBM CORP. (AVE);C/O LAW OFFICE OF ANTHONY ENGLAND, PO BOX 5307, AUSTIN, TX, 78763-5307, US

(21) Appl. No.: 11/034,561

(22) Filed: Jan. 13, 2005

(51) Int. Cl. G06F 9/00; G06F 3/00

(52) U.S. Cl. 715/859

(57) ABSTRACT

A method of presenting information to be learned includes enabling a user to select a first column of information to display and enabling the user to select a second column of information to hide. A cell in the first column corresponds to at least one cell in the second column. Responsive to the user performing a first mouse motion event over a cell in the first column, the corresponding cell or cells in the second column are displayed. Responsive to the user performing a second mouse motion event, the corresponding cells in the second column are hidden. The first mouse motion event may include moving the mouse over the cell in the second column. The second mouse motion event may include moving the mouse from a position over the cell to a position not over the cell.

### BACKGROUND

1. Field of the Present Invention

The present invention is in the field of learning tools and, more particularly, computer assisted learning tools.

2. History of Related Art

Students, professionals, and others are frequently required to learn or memorize highly specialized information and lists of data, usually in a short period of time. A number of software applications attempt to facilitate the learning/memorization process. These existing applications are dominated by flashcard or drill-type applications. In a flash card application, the user is shown a stimulus item. When the user performs a mouse action such as clicking on the appropriate location, a response associated with the stimulus items is revealed to the user.

Conventional flashcard learning tools have a number of characteristics and drawbacks. As mentioned in the preceding paragraph, existing applications tend to employ an item-matching model in which a known item provides the stimulus for an item to be remembered or learned. These applications tend to have limited sorting capability, often requiring either a specific order or a random order.

While it is inherent in the design of most conventional learning applications, the requirement that a stimulus item be shown to the user does not conform to the frequently encountered reality where a user must often supply the stimulus and the response or derive the stimulus from the response. Moreover, existing applications tend to require excessive or inconvenient user interaction during the learning process. In any application where, for example, a mouse click is required to reveal a response, the required user interaction detracts from the learning process and focuses unwanted attention on the application's interface. In addition, users cannot enter mouse clicks at the speed at which the brain is learning. In many flashcard applications, not only must users click a mouse to reveal a response, but they must also navigate the individual cards using “previous” and “next” buttons. In the context of applications designed to promote rapid learning of information, any time spent navigating the interface is time detracted from learning the material.

Existing applications do not generally permit or facilitate the rapid repeated presentation of matched items (i.e., items that a user has previously answered or demonstrated correctly). This limitation of many applications is at odds with research indicating that the number of repetitions of a memorization attempt is a key predictor of successful memorization. Furthermore, data to be learned may have a ragged or tree structure that is not compliant with the one-to-one correspondence assumption implicit in many learning applications.

### SUMMARY OF THE INVENTION

For the reasons outlined above, it is desirable to implement a memorization and learning technique that addresses or overcomes these limitations. The present invention does so with a system, method, and user interface code for facilitating the learning or memorization of information. The method includes enabling a user to select a first column of information to display and enabling the user to select a second column of information to hide where there is a correspondence between cells in the first column and cells in the second column. Responsive to the user performing a first mouse motion event over a cell in the first column, the corresponding cell or cells in the second column are displayed. Responsive to the user performing a second mouse motion event, the corresponding cells in the second column are hidden. The first mouse motion event may include moving the mouse over the cell in the second column. The second mouse motion event may include moving the mouse from a position over the cell to a position not over the cell.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing system suitable for use with one embodiment of the present invention;

FIG. 2 is a conceptual diagram of an exemplary set of information to be learned;

FIG. 3 illustrated an exemplary user interface according to one embodiment of the invention;

FIG. 4 illustrates the user interface of FIG. 3 in which a second column of data is displayed while the remaining columns of information are hidden;

FIG. 5 illustrates a technique for revealing or displaying an item to be learned that is located in one of the hidden columns according to one embodiment of the invention;

FIG. 6 illustrates a technique for revealing or displaying an item to be learned that is located in one of the hidden columns according to one embodiment of the present invention;

FIG. 7 illustrates an implementation of a sorting interface according to one embodiment of the present invention;

FIG. 8 illustrates presentation of data having a ragged or tree-like structure according to one embodiment of the present invention; and

FIG. 9 is a flow diagram of a method for learning and memorization according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

The present invention is a computer assisted method and user interface for facilitating the learning or memorization of information or data. The user interface may present information to be learned in as a set of two or more columns. Any or all of the columns may be hidden or displayed. Data that is hidden may be shown or revealed by a mouse motion event that does not require a user click or any other relatively time consuming and attention diverting input event. The interface further enables a user to sort the information according to any of several criteria applied to any of the columns of data. The interface may further include facilities for defining and displaying data having a tree like structure.

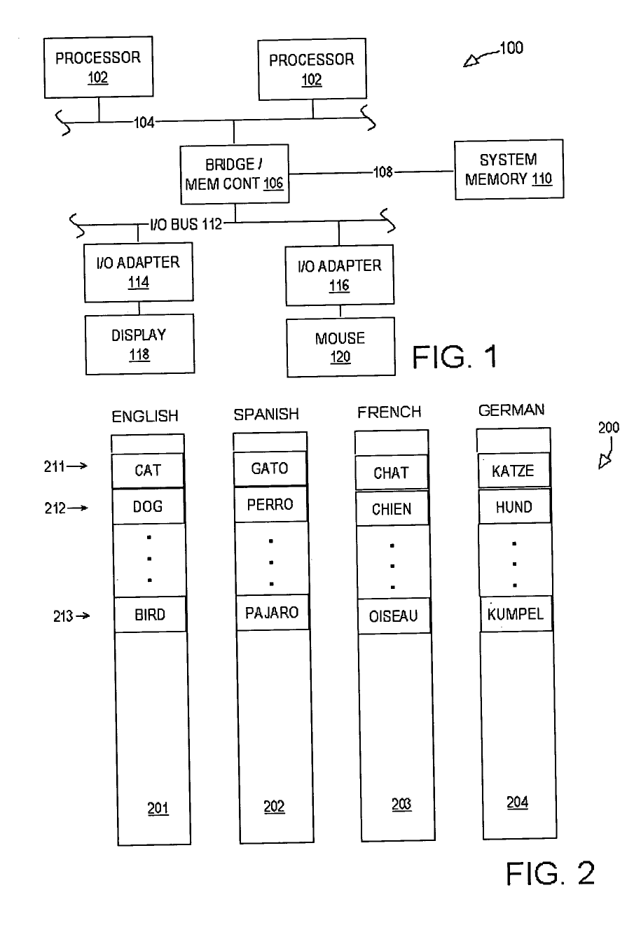

Turning now to the drawings, FIG. 1 is a block diagram of a data processing system 100 suitable for use in conjunction with the present invention. In the depicted embodiment, system 100 includes one or more general-purpose microprocessors 102, each connected to a shared, system bus or local bus 104. A bus bridge/memory controller 106 provides an interface between the local bus 104 and a memory bus 108 to which a system memory 110 is connected. Bridge 106 further provides an interface for a peripheral bus or expansion bus 112. First and second I/O adapters 114 and 116 are connected to peripheral bus 112 and, through bridge 106, to local bus 104 and processors 102. In an embodiment suitable for use with the memorization application according to the present invention, the first I/O adapter 114 is preferably a display adapter connected to a display device 118 while the second adapter 116 is preferably an input device adapter and, more specifically, an adapter for receiving a mouse or pointing device 120. Data processing system 100 is capable of executing computer readable instructions stored on a computer readable medium such as system memory 110 or a disk storage device or other nonvolatile storage device (not shown).

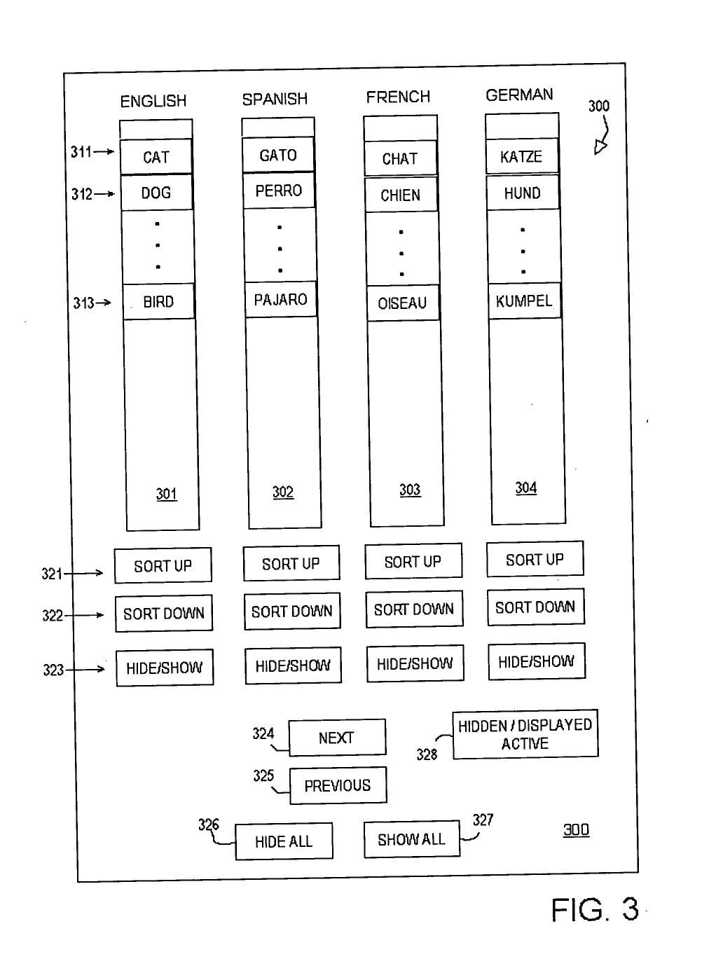

Referring now to FIG. 2, a conceptual depiction of information 200 to be learned by user is shown according to one implementation for use with the present invention is shown. In the depicted representation, information 200 includes a first column 201 of information, second column 202, a third column 203, and a fourth column 204. Other implementations may have fewer or more columns that the four shown in FIG. 2. Each column includes a plurality of cells or items that are identified by reference numerals 211 through 213.

In the depicted implementation, each column 201 through 204 corresponds to a particular language and the cells 211 through 213 contain words in the corresponding language. A set of cells 211, for example, taken from columns 201 through 204 contain the English, Spanish, French, and German words for the English word CAT. Similarly, the set of cells 212 and 213 contain the foreign language equivalents of DOG and BIRD respectively. It may be highly desirable or useful to learn the foreign language equivalents of a number of words and the present invention facilitates rapid learning and memorization.

Portions of the present invention may be implemented as computer executable instructions, stored on a computer readable medium, that, when executed, produce a rapid memorization user interface according to the present invention or otherwise facilitate rapid learning and memorization.

Referring now to FIG. 3, an exemplary rapid memorization user interface 300 according to one embodiment of the present invention is depicted. In this particular implementation of the invention, user interface 300 includes a set of two or more columns 301 through 304. The items or cells in any column share at least one common characteristic that forms the basis for the distinct columns. In the implementation of FIG. 3, for example, the cells in a particular column, such as column 303, are vocabulary words that share a common language (French in this case). Each column 301 through 304 contains a plurality of cells or items. The information presented by user interface 300 is displayed within the column/cell structure depicted in FIG. 3 such that the corresponding cells share a common characteristic. In the depicted embodiment, for example, each cell 311 through 313 contains the column-dependent language word equivalent. Thus, for example, cells 311 of columns 301 through 304 contain the English, Spanish, French, and German equivalents for the English word BIRD.

As shown in FIG. 3, the data in each column and each row is displayed. Learning/memorization of the displayed information and, more particularly, learning or memorizing the relationship between the words in one column and the words in another column is facilitated by hiding some or all of the data and enabling the user to display selected information as needed in a very rapid fashion. In addition to display and hide techniques that are described in detail below, the depicted embodiment of user interface 300, each column includes options buttons 321 through 325 that permit users to customize their learning environment to suit their needs.

In one application of the present invention, cells in the first column 301 provide a stimulus for the cells in second column 302 and, when there are additional columns, third column 303, fourth column 304, and so forth. In FIG. 3, for example, column 301 is the English language stimulus for an English-speaking user trying to learn one or more foreign vocabulary words. Thus, a cell in first column 301 provides the stimulus for the corresponding cell in the second, third, and fourth columns 302 through 304 respectively.

The depicted embodiment of user interface 300 includes functionality for sorting the displayed and hidden data according to user specified criteria. As implemented in user interface 300, for example, each column 301 through 304 includes corresponding SORT UP and SORT DOWN buttons 321 and 322. Sort buttons 321 and 322 enable a user to sort data in the corresponding column according to specified criteria.

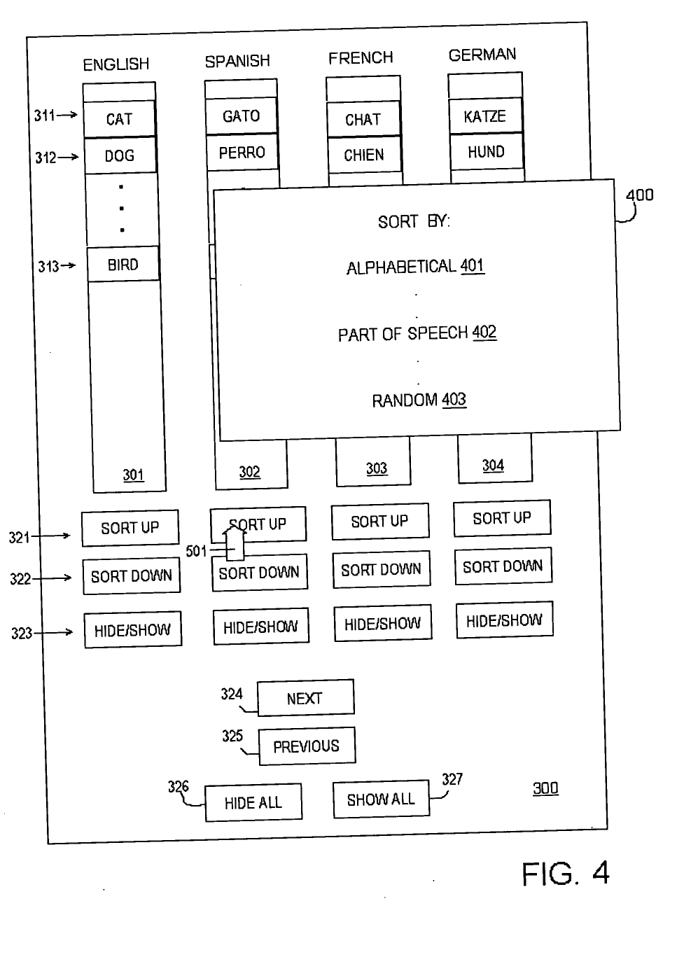

Referring momentarily to FIG. 4, an exemplary sort menu 400 is shown as being presented to the user upon selecting the sort button 321 of column 302. Sort menu 400 permits the user to sort the data in user face 300 according to selectable criteria, where the sort criteria are applied to the corresponding column. Using the application under discussion as an example, sort menu 400 includes an alphabetical and/or alphanumeric sort option 401, a categorical sort option in the form of the part of speech sort button 402, and a random number generator button 403. If the alphabetical sort option 401 is selected after clicking or activating the sort up button 321 of column 302, the data in interface 300 is sorted alphabetically, in ascending order, according to the Spanish spelling of the various words. The categorical sort option 402, as its name suggests, causes the information in interface 300 to be sorted according to a user specified category. In the foreign language application under discussion, for example, the categorical option 402 might cause the interface to sort the data according to a part of speech or some user-specified category. Sort menu 400 as depicted in FIG. 4 further includes a random sort option button 403 that, when pressed, causes user interface 300 to display the data in any random ordering.

Returning to FIG. 3 now, the depicted user interface 300 includes hide/show buttons 323 for each column 301 through 304. The hide/show buttons cause interface 300 to either display all of the cells in the corresponding column or to hide all of the cells in the corresponding column. Using the various hide/show buttons 323, the user can select any combination of columns to display and columns to hide. It is significant that show/hide option buttons 323 enable a user to display all columns 301 through 304 as well as enabling the user to hide all columns 301 through 304. In fact, the depicted embodiment of user interface 300 includes an explicit HIDE ALL button 326 and a SHOW ALL button 327 for precisely these purposes. The functionality for hiding all data, which is generally lacking in conventional flashcard applications, beneficially supports a learning mode in which the user is required to supply the stimulus as well as the response. The option buttons of the depicted embodiment of user interface 300 further include NEXT and PREVIOUS buttons 324 and 325 respectively. NEXT button 324 scrolls the data presented in columns 301 through 304 downward while PREVIOUS button 325 scrolls the data presented in columns 301 through 304 in the opposite direction.

A significant feature of the present invention is illustrated in FIG. 5 through FIG. 7. In FIG. 5, the options buttons described above (not depicted in FIG. 5) have been activated such that the data in columns 301, 303, and 304 is hidden while the data in column 302 is displayed. FIG. 5 also shows the position of an ordinary display screen cursor 501. Display screen cursors, as will be generally familiar, is on within interface 300 by moving a pointing device such as a computer mouse. In FIG. 5, the display screen cursor 501 is not positioned over any of the data cells of user interface 300. Instead, the display screen cursor 501 is positioned in a marginal portion of interface 300. With the display screen cursor in this position, user interface 300 merely displays the information in columns 301 through 304 according to the user defined settings selected with the option buttons 321 through 327.

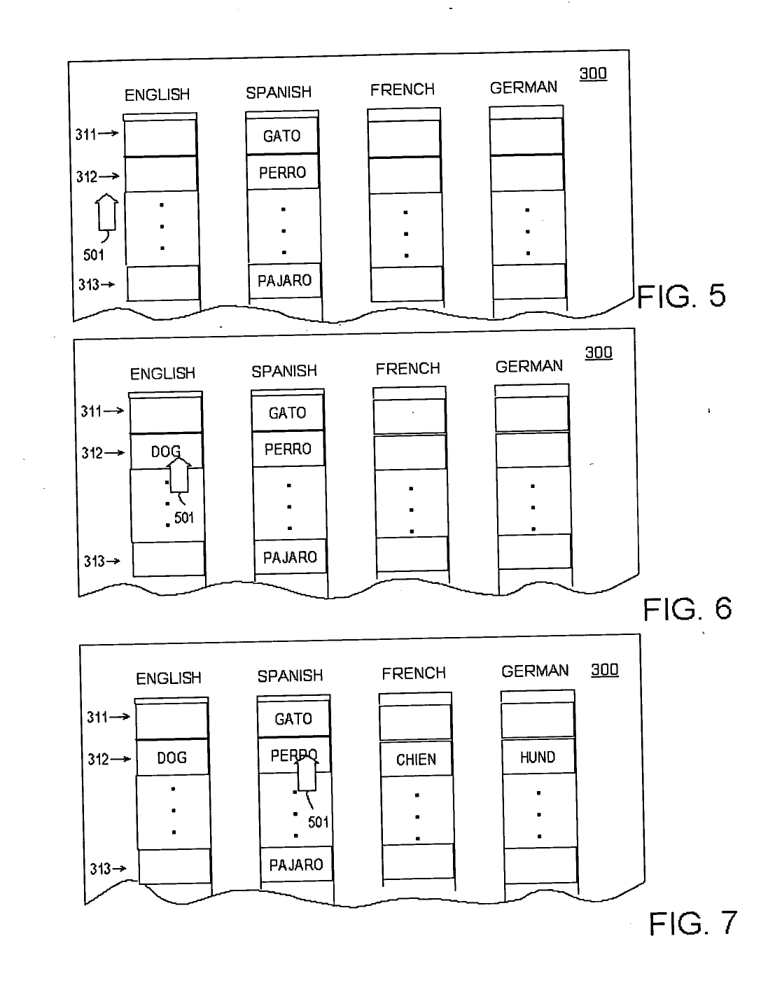

In FIG. 6, a mouse motion event has been performed to move the display screen cursor 501 to a position corresponding to cell 312 of column 301. User interface 300 incorporates mouse position listening code to monitor the location of display screen cursor 501 continuously. In response to determining that cursor 501 is positioned above hidden cell, namely, cell 312 of column 301, user interface 300 displays the corresponding cell as shown in FIG. 6. Significantly, the mouse motion event that caused interface 300 to display cell 312 of column 301 did not require the user to perform or cause any mouse event other than motion itself. In other words, cell 312 of column 301 is displayed merely by moving the mouse over the corresponding cell position within interface 300. This mouse motion event, in which the display screen cursor is moved to a position overlying a particular cell position is referred to herein as a mouse over event. Mouse over events do not require any mouse clicking or keyboard entry and are, therefore, capable of being performed rapidly.

After a user has performed a mouse over event or other suitable mouse motion event to display a portion of hidden data, the user may then perform a second mouse motion event such as returning cursor 501 to the position shown in FIG. 5, where cursor 501 is no longer positioned above any cell position of user interface 300. When this second mouse motion event occurs, referred to herein as a mouse out event, user interface 300 hides the temporarily displayed information (i.e., the information displayed in FIG. 6) from view as shown in FIG. 5. By using mouse motion events as the catalyst for displaying and hiding information to be learned, user interface 300 facilitates extremely rapid drill exercises. Whereas the rate or frequency at which conventional click-based flashcard application can display information is limited by the user's ability to click a mouse rapidly (as well as any “debouncing” facilities that attempt to prevent inadvertent double clicks), user interface 300 according to the present invention is capable of presenting and hiding information at a rate that is limited only by the user's ability to move the mouse.

In the embodiment depicted in FIG. 6, information is displayed by moving the cursor 501 over the cell containing the information to be learned or remembered (i.e., the cell containing information that is currently hidden). This embodiment is referred to herein as being a hidden cell active implementation. In the implementation of interface 300 depicted in FIG. 7 (displayed cell active), hidden information is displayed by moving cursor 501 over a cell where information is displayed. Using the particular example depicted in FIG. 7, the information in columns 301, 303, and 304 is hidden information while the information in column 302 is displayed. When a user wishes to display the information in a particular cell of column 301, for example, the user mouses over the corresponding cell in the displayed column (i.e., column 302). As depicted in FIG. 7, a user displays cell 312 of column 301 (the hidden cell) by mousing over the cell 312 of column 302 (the corresponding displayed cell). The different implementations illustrated by FIG. 6 and FIG. 7 enable users to select whether they wish to emphasize the hidden information or the displayed information in their drills. Referring back to FIG. 3 momentarily, user interface 300 includes a facility (HIDDEN/DISPLAYED ACTIVE button 328) enabling the user to toggle between the hidden cell active and displayed cell active modes.

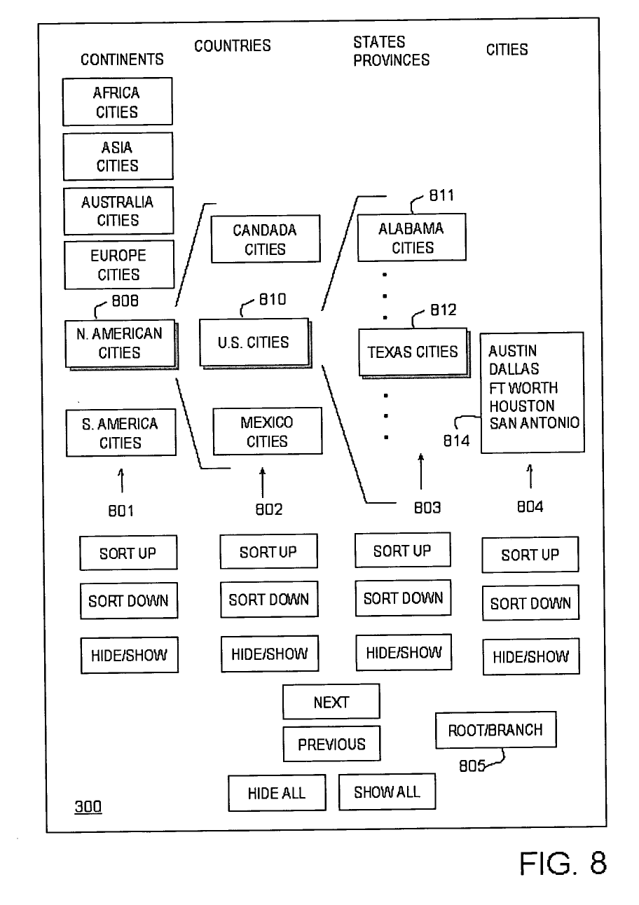

Referring now to FIG. 8, an embodiment of interface 300 is shown to emphasize the ability of the present invention to enable users to drill or memorize information that is not “flat” where flat information refers to the one-to-one correspondence between cells in different columns. In the embodiment of FIG. 8, user interface 800 displays information that has a tree-like structure in which a cell of information in a column such as column 801 corresponds to two or more cells of information in column 802. In the particular example shown, suitable for user attempting to learn the names of significant cities in different geographic territories, various operational modes are contemplated. In one implementation, mousing over a cell in any column will display all of the corresponding cells in the column to the right of the moused-over cell. In the depicted implementation, this embodiment enables the user to visualize all of the subsets of a selected cell. In tree structure terminology, mousing over a selected cell displays the “branches” or “leaves” of the selected cell. As an example, mousing over the cell 810 identified as “U.S. CITIES” displays the cells 811 through 812 in column 803 identifying the fifty U.S. states. Mousing over the TEXAS CITIES cell 812 then displays the list of Texas cities identified by reference numeral 814 in column 804.

In an alternative operating mode, user interface 800 enables a user to display the “root cells” of a selected cell. In this mode, when a user mouses over a particular cell, all of the roots to the left of the selected cell are displayed. If, for example, a user mouses over the list of Texas cities identified by reference numeral 814, the TEXAS cities cell 812, the U.S. CITIES cell 810, and the N AMERICAN CITIES cell 808 are all displayed. This implementation beneficially enables a user to visualize the supersets of a cell or list of cells to be learned. In the depicted embodiment, the user can toggle between the root mode in which root cells (cells to the left) are displayed and the branch mode in which branch cells (cells to the right) are displayed by clicking on the ROOT/BRANCH BUTTON identified by reference numeral 805. Like the user interface 300 depicted in FIG. 3, the user interface 800 depicted in FIG. 8 includes facilities for sorting information according to selected columns and for displaying and hiding columns as desired.

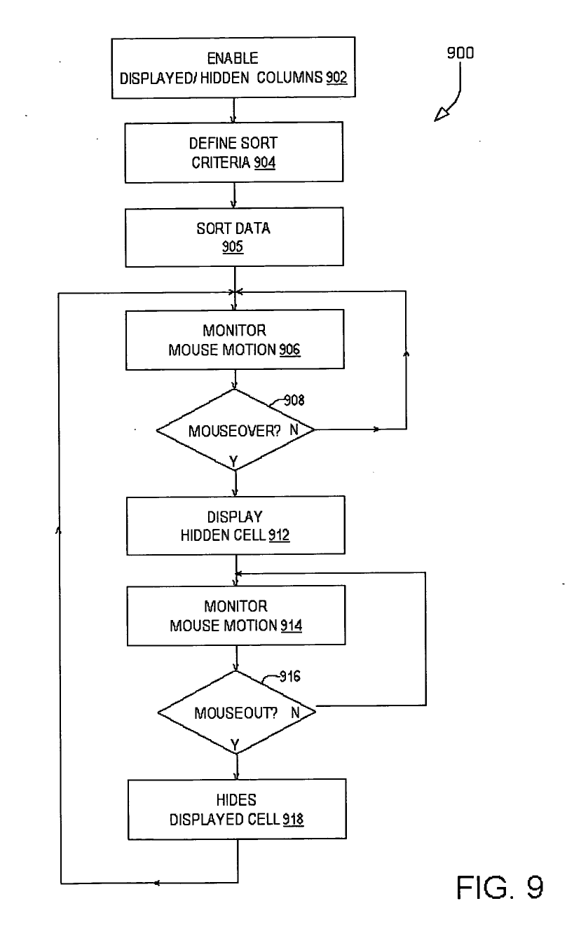

As indicated previously, some embodiments of the present invention are implemented as a set or sequence of computer executable instructions stored on a computer readable medium. The instructions, when executed by a system such as data processing system 100, perform a method 900 as depicted in FIG. 9 for enabling a user to drill or learn a set of information.

In the depicted embodiment of method 900 a user selects or enables (block 902) columns of information to be hidden and/or displayed. A user may also then define (block 904) sort criteria and sort (block 905) the data according to the selected criteria. Data may be sorted based on any of the columns as described above with respect to the user interface of FIG. 3.

Following definition of the optional parameters, method 900 includes monitoring (block 906) mouse movement events. As long as the mouse motion monitoring does not detect a mouse over event (a movement of a mouse over a cell location in one of the columns), the user interface takes no action and remains in a mouse-monitoring mode. If, however, a mouse over event is detected in block 908, the user interface displays (block 912) the information associated with the selected cell (the cell over which the mouse is moved).

The method according to FIG. 9 then continues to display while resuming the monitoring (block 914) of the mouse motion. Until a mouse out event is detected, the user interface continues to display the selected cell. When a mouse out event occurs as indicated by block 916, the user interface then hides (block 918) the cell and resumes the monitoring for a mouse over event as described above with respect to block 906.

It will be apparent to those skilled in the art having the benefit of this disclosure that the present invention contemplates a system and method for facilitating user learning through rapid drill and memorization training. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A computer program product, comprised of a set of computer executable instructions stored on a computer readable medium, said computer executable instructions for facilitating a user to learn information, comprising:
computer code means for displaying a first column of information and a second column of information, wherein each cell in the first column of information represents a stimulus and a corresponding cell in the second column represents a response;
computer code means for hiding the second column of information from view;
computer code means for displaying a cell of information in the second column of information in response to a first user motion event; and
computer code means for hiding the cell of information responsive to a second user motion event.

2. The computer program product of claim 1, wherein the first user motion event comprises a mouse over of the cell by the user.

3. The computer program product of claim 2, wherein the second user motion event comprises a mouse out of the first cell by the user.

4. The computer program product of claim 1, further comprising computer code means for enabling a user to hide the first column of information from view and computer code means for enabling a user to hide both the first and second columns of information from view.

5. The computer program product of claim 1, further comprising computer code means for sorting the data in the first column according to selectable sort criteria.

6. The computer program product of claim 5, wherein the selectable sort criteria includes random sorting, alphabetical sorting, and categorical sorting.

7. The computer program product of claim 1, wherein a cell in the first column corresponds to multiple cells in the second column and wherein highlighting a cell in the first column reveals the multiple corresponding cells in the second column.

8. A method of presenting information to be learned, comprising:
enabling a user to select a first column of information to display on a display screen;
enabling the user to select a second column of information to hide, wherein a cell in the first column corresponds to at least one cell in the second column;
responsive to the user performing a first mouse motion event over a cell in the first column of information, displaying the corresponding cells in the second column; and
responsive to the user performing a second mouse motion event hiding the corresponding cells in the second column.

9. The method of claim 8, wherein the first mouse motion event comprises moving the mouse over the cell in the second column.

10. The method of claim 9, wherein the second mouse motion event comprises moving the mouse from over the cell to a position not over the cell.

11. The method of claim 8, wherein a cell in the first column corresponds to multiple cells in the second column and wherein performing the first mouse over event on the cell in the first column displays all of the multiple cells in the second column.

12. The method of claim 11, further comprising the user to perform a mouse over event on any of the multiple cells in the second column and, responsive thereto, displaying the corresponding element in the first column.

13. The method of claim 1, further comprising enabling the user to select the first and second column for hiding and enabling the user to select the first and second column for displaying.

14. The method of claim 1, further comprising enabling the user to sort the information according to the first column information based on a sort criteria.

15. The method of claim 14, wherein the sort criteria include sort criteria selected from alphanumeric ordering, categorical ordering, and random ordering.

16. A data processing system including a processor, memory, display means, and pointing device means, comprising:
means for presenting a user interface containing cells of information to be learned;
means for enabling a user to hide, within the interface, all of the cells;
means for enabling the user to display a hidden cell by moving a cursor associated with the pointing device means over the hidden cell;
means for enabling the user to hide a displayed cell by moving the cursor away from the cell.

17. The system of claim 16, further comprising means for displaying a first column of the information to be learned and for hiding a second column of the information.

18. The system of claim 16, further comprising means for displaying at least one cell in the second column responsive to a mouse movement event.

19. The system of claim 18, where the mouse movement event comprises moving the mouse across a location in the second column corresponding to the cell to be displayed.

20. The system of claim 18, where the mouse movement event comprises moving the mouse across a corresponding cell in the first column.
